(19) United States
(12) Patent Application Publication
(10) Pub. No.: US 2009/0017684 A1
(43) Pub. Date: Jan. 15, 2009

(54) Connector and pins thereof

(76) Inventor: Chin-Huang Lin, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,841

(22) Filed: Oct. 18, 2007

(30) Foreign Application Priority Data
Jul. 11, 2007 (TW) 96211294

(51) Int. Cl. H01R 13/648; H01R 4/26

(52) U.S. Cl. 439/610; 439/405; 439/417

(57) ABSTRACT

A connector includes an insulating body, a plurality of pins, and two covering bodies. The insulating body has a receiving space, and a plurality of pin slots. Each pin has a contacting portion and a piercing portion. Each covering body has a plurality of wire slots and through holes that respectively link to the wire slots. The pins are respectively installed in the pin sots so that the contacting portions respectively extend into the insulating body. The piercing portions are disposed in a staggering method and extend into the receiving space. When the two covering bodies are combined with the insulating body, the piercing portions respectively pass through the through holes and enter into the wire slots to pierce through the covering layer and electrically connect the conducting wires. Therefore, the insulating body, the covering bodies, and the cable can be easily assembled, and the cost is reduced.

### BACKGROUND OF THE INVENTION

1. Field of the Invention

The present invention relates to a connector. In particular, this invention relates to a connector that is connected with a cable, without using the welding method to connect the cable.

2. Description of the Related Art

Connectors can be divided into a variety of types, such as a memory card connector, a flexible print circuit board connector, a connector for computers, digital TVs, or multimedia equipments, etc. The HDMI (high definition multimedia) connector is a new transmission interface for next generation multimedia devices. It can be used for the DVD player, the set-top box, or the digital TV. The video and the audio data do not be transmitted in a separating way again. The maximum transmission speed is 5 Gb/s. It can transmit the image data and 8-channel audio signals. It does not use the compressed digital data to transmit the video and the audio data. The signal disturbance and the signal attenuation caused during the digital-to-analog converting process are reduced. Therefore, the HDMI transmission interface has been installed in the new products produced by SONY, Panasonic, Philips, Samsung, LG, CHIMEI, and AUS.

The dimension of the HDMI connector is small. Taiwan patent M264696, published on 11 May 2005, discloses a welded HDMI connector. The conducting wires of the cable are welded to the welding portion of the pins of the welded HDMI connector so that the pins are electrically connected with the cable. Next the welded HDMI connector is plugged with the connected connector to transmit the video and audio signals. The HDMI connector can be divided into an A-type and a C-type. The dimension of the C-type HDMI connector is smaller than the dimension of the A-type HDMI connector.

However, by using the welding method to fasten the cable to the pins of the HDMI connector, the conducting wires of the cable has to be manually welded onto the welding portions of the pins one by one. It is time-consumed. Furthermore, during the welding process, poisonous gas is generated. It is bad for the environment protection and the worker's health. Moreover, by using the manual welding method, welding location may be bad due to the worker's skill. The characteristic of the HDMI connector for transmitting signal is affected, or the HDMI connector is bad. The cost increases. Because the dimension of the pins of the C-type HDMI connector is small, it is very difficult to weld the conducting wires to the welding portion of the pin.

### SUMMARY OF THE INVENTION

One particular aspect of the present invention is to provide a connector. The required assembling time is reduced. It does not need to use the welding method to fasten the conducting wires to the pins. It is good for environment protection and the worker's health.

The connector includes an insulating body having a body portion and a plugging portion, a plurality of pins, and two covering bodies. The body portion has a receiving space, and a plurality of pin slots linked to the plugging portion. Each of the pins has a contacting portion and a piercing portion. The pins are respectively installed in the pin sots. The contacting portions respectively extend into the plugging portions. The piercing portions are disposed in a staggering method and extend into the receiving space. The thickness of the piercing portion is larger than the thickness of the contacting portion. Each of the two covering bodies has a plurality of wire slots and a plurality of through holes that respectively link to the wire slots. The two covering bodies are combined with the body portion in an upper location and a lower location. Thereby, the piercing portions of the pins respectively pass through the through holes and enter into the wire slots.

The present invention has the following characteristics. The wire slots of the two covering bodies can be installed with the conducting wires and the covering layers of the cable. The piercing portion of the pin can pierce through the covering layer to electrically connect with the conducting wires of the cable. Therefore, the insulating body, the covering bodies, and the cable can be easily assembled. It does not need to use the welding method to fasten the conducting wires onto the pins. The assembling time is reduced, and the problem of the welding location being bad is avoided. The cost is reduced, and it is good for the environment protection and the worker's health.

Moreover, because the thickness of the piercing portion of the pin is larger than the thickness of the contacting portion, the strength of the piercing portion is enhanced. The problem of the piercing portion cannot pierce through the covering layer of the cable due to the connector is miniaturized is avoided.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an exploded perspective view of the present invention;

FIG. 2 is a first perspective view of the pin of the first embodiment of the present invention;

FIG. 3 is a second perspective view of the pin of the first embodiment of the present invention;

FIG. 4 is a first perspective view of the pin of the second embodiment of the present invention;

FIG. 5 is a second perspective view of the pin of the second embodiment of the present invention;

FIG. 6 is a cross-sectional view of part of the present invention; and

FIG. 7 is an assembly perspective view of the present invention.

### DETAILED DESCRIPTION OF THE PREFERRED EMBODIMENTS

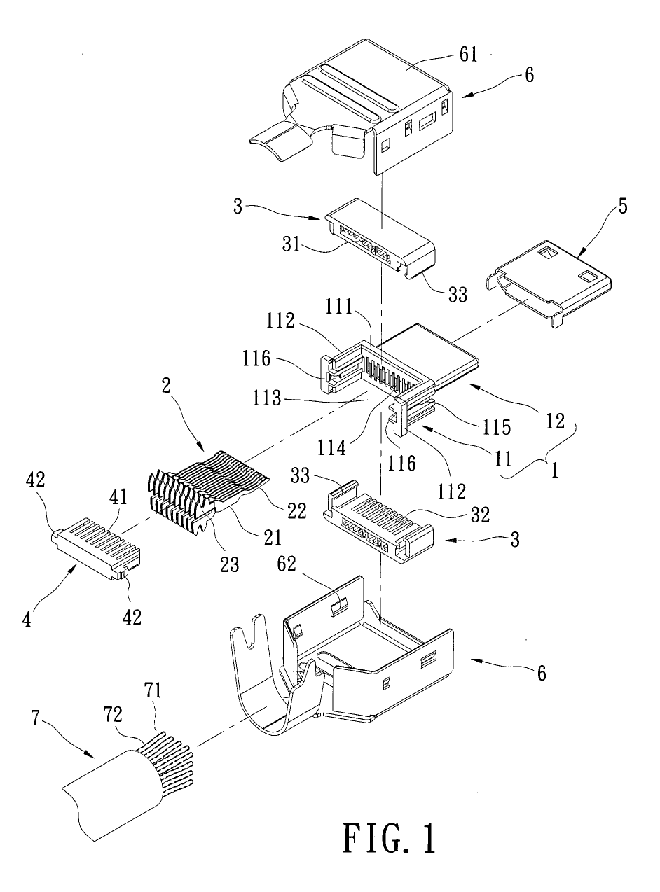

Reference is made to FIG. 1, which shows a connector of the present invention. The connector is used for connecting a cable 7. In this embodiment, the connector is a C-type HDMI connector. The connector includes an insulating body 1, a plurality of pins 2, two covering bodies 3, and a positioning base 4.

The insulating body 1 is made of plastic material. The insulating body 1 has a body portion 11 and a plugging portion 12. The body portion 11 has a front board 111 and two side boards 112 connected with the two sides of the front board 111. The front board 111 and the two side boards 112 forms a receiving space 113. The front board 111 has a plurality of pin slots 114 that links to the plugging portion 12. There is a concave wedging slot 115 at the outside edge of each of the two side boards 112, and a concave plugging slot 116 at the inside edge of each of the two side boards 112 that links to the receiving space 113.

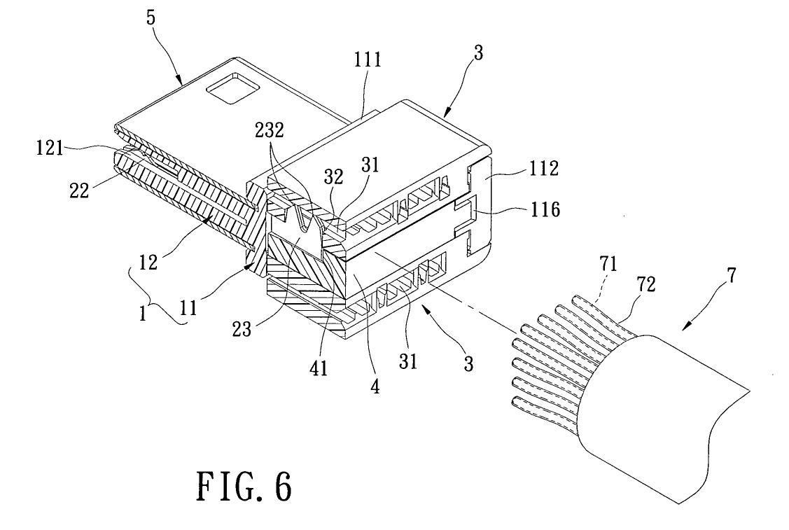

The plugging portion 12 has a flat flaked shape. The rear end of the plugging portion 12 is connected with the front board 111 of the body portion 11 in a single piece so that the plugging portion 12 is connected with the front side of the body portion 11. The front end of the plugging portion 12 has a concave plugging opening 121 (as shown in FIG. 6) that extends backwards into the interior of the plugging portion 12 in a proper depth. Each pin sot 114 links to the plugging opening 121. The plugging portion 12 is used for plugging with a connected connector (not shown in the figure).

The pin 2 is made of conductive metal material, and is formed by a punching method. Each pin 2 has a base portion 21, a contacting portion 22, and a piercing portion 23. The base portion 21 has a horizontal rectangular flaked shape. The contacting portion 22 extends from one front end of the base portion 21 and has a flake with a predetermined shape. The piercing portion 23 is opposite to the contacting portion 22 and extends from a rear end of the base portion 21. The thickness of the piercing portion 23 is larger than the thickness of the contacting portion 22.

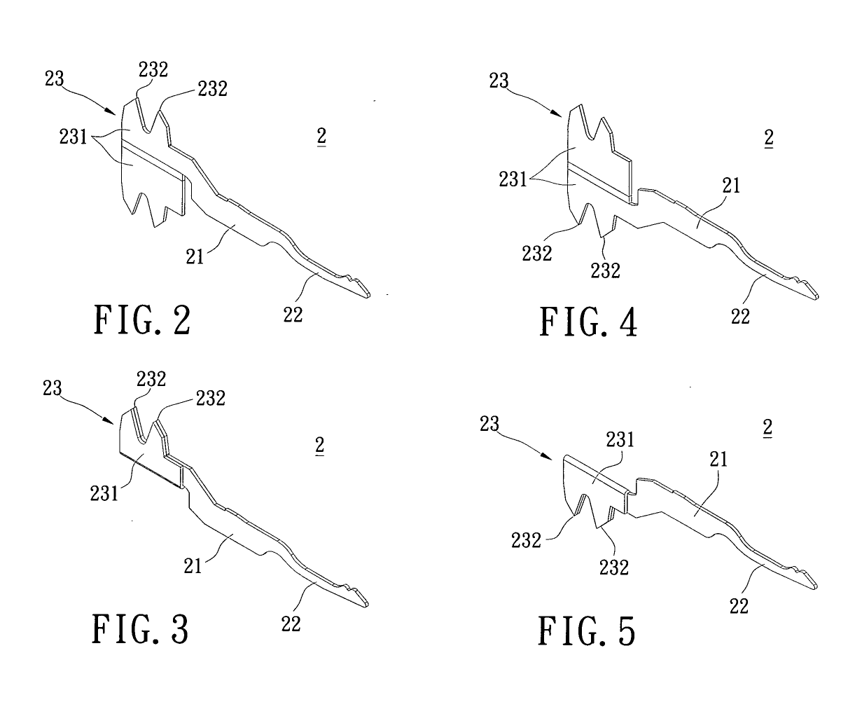

Reference is made to FIGS. 2˜5. In this embodiment, the piercing portion 23 has two piercing flakes 231. One piercing flake 231 is connected with the base portion 21 in a single piece. The second piercing flake 231 is connected with one end of the piercing flake 231 in a single piece. The second piercing flake 231 is bent backwards and stacked on the surface of the piercing flake 231 of the base portion 21. Thereby, the piercing portion 23 is formed. Therefore, the thickness of the piercing portion 23 is larger than the thickness of the base portion 21 and the contacting portion 22. The edge of the two piercing flakes 231 of the piercing portion 23 has two sharp piercing ends 232.

The two covering bodies 3 are made of plastic material and are symmetrical. The two covering bodies 3 respectively have a plurality of wire slots 31 from the front side to the rear side. On the upper/lower surface of the two covering bodies 3, there is a plurality of through holes 32 from the upper/lower side to the lower/upper side of the two covering bodies 3. The through holes 32 respectively link to the wire slots 31. A wedging hook 33 protrudes from each side of the left and the right sides of the two covering bodies 3.

The positioning base 4 is made of plastic material and is insulated. Each of the upper surface and the lower surface of the positioning base 4 has a plurality of concave positioning slots 41, and each of the left side and the right side has a convex rib 42.

The cable 7 has a plurality of conducting wires 71 and a covering layer 72 wrapped around the conducting wires 71.

Reference is made to FIGS. 1, 3, 5 and 6. When the connector is assembled, the base portions 21 of the pins 2 are respectively installed in the corresponding pin slots 114. The contacting portions 22 respectively extend into the plugging opening 121 of the plugging portion 12 of the insulating body 1 to electrically connect the pins of the connected connector. The piercing portions are disposed in a staggered method and extend into the receiving space 113 of the body portion 11 of the insulating body 1. The positioning base 4 is combined with the body portion 11 of the insulating body 1. The convex rib 42 of the positioning base 4 slides into the plugging slot 116 of the body portion 11 and is combined with the plugging slot 116 to fasten the positioning base 4 in the receiving space 113. At the same time, one edge of the piercing portion 23 of the pin 2 is positioned in the positioning slot 41 of the positioning base 4, and the positioning base 4 separates the piercing portion 23 into an upper portion and a lower portion.

When the connector is connected with the cable 7, firstly, the conducting wires 71 and the covering layers 72 of the cable 7 are respectively located in the wire slots 31 of the two covering bodies 3. Next, the two covering bodies 3 are combined with the body portion 11 of the insulating body 1 in an upper location and a lower location. In this embodiment, the wedging hooks 33 of the two covering bodies 3 are respectively wedged with the corresponding wedging slots 115 of the body portion 11 so that the two covering bodies 3 are firmly combined with the upper side and the lower side of the body portion 11.

When the two covering bodies 3 are combined with the body portion 11, the piercing portions 23 of the pins 2 respectively pass through the corresponding through holes 32 and enter into the wire slots 31 (as shown in FIG. 6). This means that each of through holes 32 has a function to guide the piercing portion 23 of the pin 2. Thereby, the piercing ends 232 of the piercing portion 23 of the pins 2 respectively pierce through the covering layer 72 of the cable 7 located in the wire slot 31 and the pins 2 are electrically connected with the conducting wires 72 of the cable 7 so that the conducting wires 72 of the cable 7 are electrically connected with the pins 2 located in the insulating body 1.

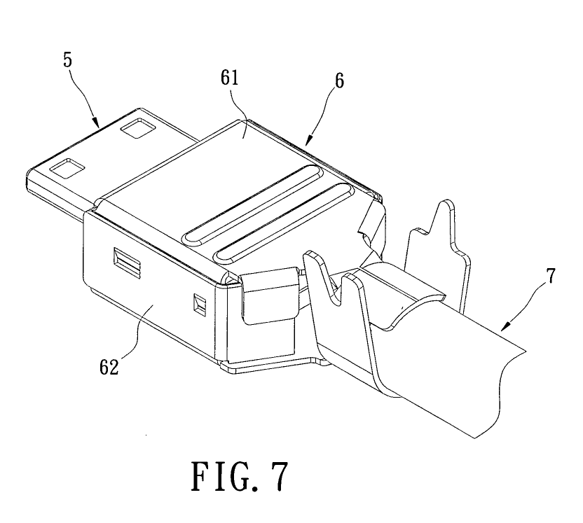

Reference is made to FIGS. 1 and 7. The connector further includes a metal housing 5 and a metal shell 6. The shape of the metal housing 5 matches the shape of the plugging portion 12 of the insulating body 1. The metal housing 5 wraps around the plugging portion 12. The metal shell 6 covers around the body portion and the two covering bodies 3 and has a function to fasten the cable 7. The metal shell 6 includes an upper covering body 61 and a lower covering body 62 that can wedged with each other.

The two covering bodies 3 can be installed with the conducting wires 71 and the covering layers 72 of the cable 7. When the two covering bodies 3 are combined with insulating body 1, the piercing portion 23 of the pin 2 can pierce through the covering layer 72 to electrically connect the conducting wire 71 of the cable 7. Therefore, the insulating body 1, the covering bodies 3, and the cable 7 can be easily assembled. It does not need to use the welding method to fasten the conducting wires 71 onto the pins 2. The assembling time is reduced, and the problem of the welding location being bad is avoided. The cost is reduced, and it is good for the environment protection and the worker's health.

Moreover, because the thickness of the piercing portion 23 of the pin 2 is larger than the thickness of the base portion 21 and the contacting portion 22, the strength of the piercing portion 23 is enhanced. The problem of the piercing portion cannot pierce through the covering layer 72 of the cable 7 due to the connector is miniaturized is avoided.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A connector, comprising:
an insulating body having a body portion and a plugging portion, wherein the body portion has a receiving space, and a plurality of pin slots linked to the plugging portion;
a plurality of pins, wherein each of the pins has a contacting portion and a piercing portion, the pins are respectively installed in the pin sots, the contacting portions respectively extend into the plugging portions, the piercing portions are disposed in a staggering method and extend into the receiving space, and the thickness of the piercing portion is larger than the thickness of the contacting portion; and
two covering bodies, wherein each of the two covering bodies has a plurality of wire slots and a plurality of through holes that respectively link to the wire slots, the two covering bodies are combined with the body portion in an upper location and a lower location so that the piercing portions of the pins respectively pass through the through holes and enter into the wire slots.

2. The connector as claimed in claim 1, wherein the body portion has a front board and two side boards connected with two sides of the front board, the front board and the two side boards form a receiving space, the front board has the pin slots, an front side of the plugging portion has a concave plugging opening that links to the pin slots, and the contacting portions of the pins extend into the plugging opening.

3. The connector as claimed in claim 1, wherein each of the pins has a base portion, the base portions of the pins are respectively installed in the pin slots, the contacting portion extends from one side of the base portion, and the piercing portion is opposite to the contacting portion and extends from a second side of the base portion.

4. The connector as claimed in claim 3, wherein the piercing portion of the pin has two piercing flakes, one piercing flake is connected with the base portion in a single piece, the second piercing flake is connected with the piercing flake in a single piece, and the second piercing flake is bent backwards and stacked on a surface of the piercing flake connected with the base portion.

5. The connector as claimed in claim 1, wherein the edge of the piercing portion of the pin has two sharp piercing ends.

6. The connector as claimed in claim 1, wherein each of two sides of the two covering bodies has a wedging hook, each of two sides of the body portion has a concave wedging slot, and the wedging hooks of the two covering bodies are wedged with the wedging slots of the body portion.

7. The connector as claimed in claim 1, further comprising a positioning base, each of an upper surface and a lower surface has a plurality positioning slots, the positioning base is combined with the receiving space of the body portion and separates the piercing portion into an upper portion and a lower portion, and edges of the piercing portions are respectively positioned in the positioning slots.

8. The connector as claimed in claim 1, further comprising a metal housing wrapping around the plugging portion.

9. The connector as claimed in claim 1, further comprising a metal shell covering around the body portion and the two covering bodies.

10. The connector as claimed in claim 1, wherein the connector is a HDMI connector.

11. A pin of a connector, comprising:
a base portion;
a contacting portion extending from one side of the base portion; and
a piercing portion being opposite to the contacting portion and extending from a second side of the base portion, wherein a thickness of the piercing portion is larger than a thickness of the contacting portion.

12. The pin of a connector as claimed in claim 11, wherein the piercing portion has two piercing flakes, one piercing flake is connected with the base portion in a single piece, the second piercing flake is connected with the piercing flake in a single piece, and the second piercing flake is bent backwards and stacked on a surface of the piercing flake connected with the base portion so that the thickness of the piercing portion is larger than the thickness of the base portion and the contacting portion.

13. The pin of a connector as claimed in claim 11, wherein the edge of the piercing portion has two sharp piercing ends.
